(19) United States
(12) Patent Application Publication
(10) Pub. No.: US 2010/0026439 A1
(43) Pub. Date: Feb. 4, 2010

(54) Antenna For Near Field And Far Field Radio Frequency Identification

(75) Inventors: Xianming Qing, Singapore (SG); Zhining Chen, Singapore (SG)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: AGENCY FOR SCIENCE, TECHNOLOGY AND RESEARCH, Singapore (SG)

(21) Appl. No.: 12/375,846

(22) PCT Filed: Aug. 1, 2006
(86) PCT No.: PCT/SG2006/000216

§ 371 Date: Jul. 27, 2009

(51) Int. Cl. H01F 38/14

(52) U.S. Cl. 336/200

(57) ABSTRACT

In accordance with an embodiment of the invention, there is disclosed an antenna for radio frequency identification. The antenna comprises a first radiating element for operating a first mode of radio frequency identification using a first current. The antenna further comprises a second radiating element for operating a second mode of radio frequency identification using a second current. Specifically, at least one of a portion of the first radiating element forms a portion of the second radiating element and a portion of the second radiating element forms a portion of the first radiating element. When the first radiating element is excited by the first current, the first radiating element generates a first field for providing the first mode of radio frequency identification, and when the second radiating element is excited by the second current, the second radiating element generates a second field for providing the second mode of radio frequency identification.

### FIELD OF INVENTION

The invention relates generally to antennas. In particular, it relates to an antenna for near field and far field radio frequency identification applications.

### BACKGROUND

Radio frequency (RF) communication technology is widely used in modern communication systems. One example is a radio frequency identification (RFID) system. In an RFID system, RFID reader antennas are used to transmit and receive RF signals to and from RFID tags. Information stored in the RFID tags is usually editable and therefore updateable. The RFID system is therefore commonly used in logistical applications, such as for managing the flow of articles in a warehouse or the inventory of books in a library.

RFID systems are generally classified as near field or far field RFID systems. In the near field RFID systems, communication between the RFID reader and the tag is usually achieved by inductive coupling of magnetic fields, or by capacitive coupling of electric fields. Most of the near field RFID systems are inductive coupling systems where antenna coils are used to generate the required magnetic fields. The near field RFID systems are usually operated at frequencies that are lower than 30 megahertz (MHz), typically at 13.56 MHz. Near field RFID systems typically have an operating distance of less than one meter.

In the far field RFID systems, the communication between the RFID reader and the tag is achieved by transmission and reception of electromagnetic waves. The far field RFID reader emits RF energy through an antenna to the RFID tag, where part of the RF energy is then reflected from the RFID tag and detected by the RFID reader. The far field RFID systems have a comparatively longer operating distance to the near field RFID systems. The detection range of a typical far field RFID system operating at ultra-high frequency (UHF) band may exceed 4 meters.

However, at present there is no single RFID antenna that is capable of supporting both near field and far field RFID communications. The advantage of providing a single RFID antenna for supporting both near field and far field RFID communications is desirable for system integration.

There is therefore a need for an antenna that is capable of supporting both near field and far field RFID communications.

### SUMMARY

Embodiments of the invention are disclosed hereinafter for use in near field and far field RFID applications and for facilitating system integration.

In accordance with an embodiment of the invention, there is disclosed an antenna for near field and far field radio frequency identification. The antenna comprises a first radiating element for operating a first mode of radio frequency identification using a first current. The antenna further comprises a second radiating element for operating a second mode of radio frequency identification using a second current. Specifically, at least one of a portion of the first radiating element forms a portion of the second radiating element and a portion of the second radiating element forms a portion of the first radiating element. When the first radiating element is excited by the first current, the first radiating element generates a first field for providing the first mode of radio frequency identification, and when the second radiating element is excited by the second current, the second radiating element generates a second field for providing the second mode of radio frequency identification.

In accordance with another embodiment of the invention, there is disclosed a method for configuring an antenna for radio frequency identification. The method involves the step of providing a first radiating element for operating a first mode of radio frequency identification using a first current. The method further involves the step of providing a second radiating element for operating a second mode of radio frequency identification using a second current. Specifically, at least one of a portion of the first radiating element forms a portion of the second radiating element and a portion of the second radiating element forms a portion of the first radiating element. When the first radiating element is excited by the first current, the first radiating element generates a first field for providing the first mode of radio frequency identification, and when the second radiating element is excited by the second current, the second radiating element generates a second field for providing the second mode of radio frequency identification.

### BRIEF DESCRIPTION OF DRAWINGS

Embodiments of the invention are described in detail hereinafter with reference to the drawings, in which:

FIG. 1 is a perspective view of an antenna according to a first embodiment of the invention;

FIG. 2 illustrates the operational principles of the antenna of FIG. 1;

FIG. 3a is a graph showing the measured returned loss of the antenna of FIG. 1 at 13.56 MHz;

FIG. 3b is a graph showing the measured field response of the antenna of FIG. 1 at 13.56 MHz;

FIG. 3c is a graph showing the measured returned loss of the antenna of FIG. 1 at UHF band;

FIG. 3d is a graph showing the measured gain and axial ratio of the antenna of FIG. 1 at UHF band;

FIGS. 4a to 4d illustrate further embodiments of the antenna of FIG. 1;

FIGS. 5a and 5b illustrate exemplary configurations of the first and second radiating elements of the antenna of FIG. 1; and

FIGS. 6a and 6b illustrate exemplary configurations of the second radiating element of the antenna of FIG. 1.

### DETAILED DESCRIPTION

With reference to the drawings, an antenna for near field and far field radio frequency identification (RFID) according to embodiments of the invention is disclosed.

For purposes of brevity and clarity, the description of the invention is limited hereinafter for use in near field and far field RFID applications. This however does not preclude various embodiments of the invention from other applications that require similar operating performance as the near field and far field RFID applications. The operational and functional principles fundamental to the embodiments of the invention are common throughout the various embodiments.

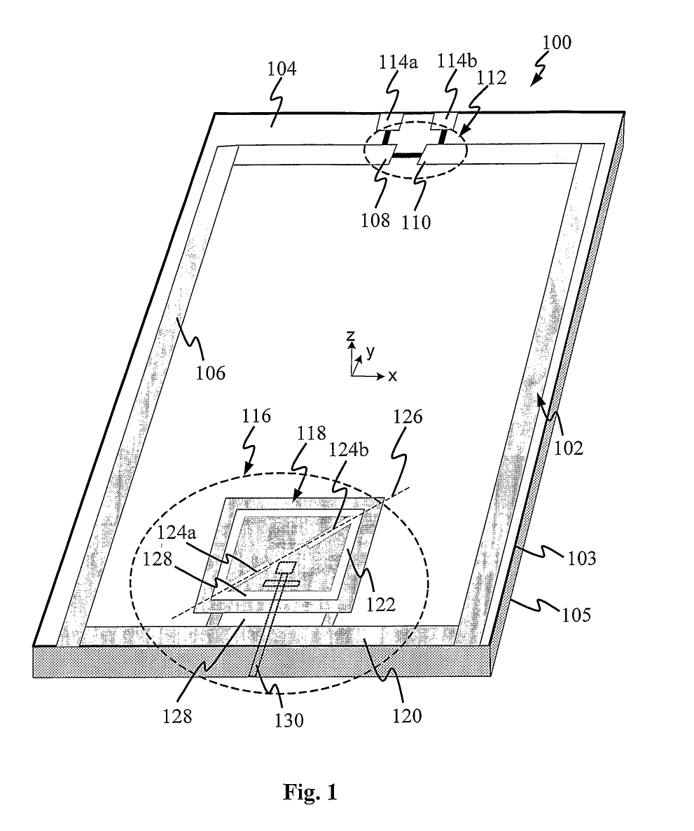

In the detailed description provided hereinafter and illustrations provided in FIGS. 1 to 6 of the drawings, like elements are identified with like reference numerals.

Embodiments of the invention are described in greater detail hereinafter for an antenna for use in near field and far field RFID applications.

With reference to FIG. 1, an antenna 100 according to a first embodiment of the invention is shown. The antenna 100 has a first radiating element 102. The first radiating element 102 is used for generating a magnetic field to power up RFID tags and detecting the signals from the RFID tags.

The first radiating element 102 is preferably formed on a first side 103 of a substrate 104. The substrate 104 is preferably planar. Examples of the substrate 104 are printed circuit boards (PCBs) and boards made of non-conductive material such as foams.

The following description of the antenna 100 is made with reference to an x-axis, a y-axis and a z-axis. The three axes are perpendicular to each other. The x and y axes extend along the substrate 104 and are coincident therewith.

The first radiating element 102 comprises a loop element 106. The loop element 106 is preferably continuous and has a geometrical shape such as a polygon, an ellipse, a circle or a semi-circle. The loop element 106 further has a first free end 108 and a second free end 110.

An impedance matching network 112 is preferably connectable to the first and second free ends 108, 110 of the first radiating element 102 such that the first and second free ends 108, 110 are interconnected. The impedance matching network 112 provides matching of the impedances between the antenna 100 and a first feed (not shown). The first feed is used to provide the first radiating element 102 with a first current for generating a first field. The first field powers up RFID tags and detect RFID signals from the RFID tags. The detected RFID signals are then received by the first feed via the first radiating element 102. The first feed is preferably connected to the first radiating element via input terminals 114a, 114b of the impedance matching network 112.

The first radiating element 102 is suitable for operating at high frequency (HF) mode and is capable of generating magnetic fields for near field RFID applications. An exemplary operating frequency of the first radiating element 102 is the regulatory frequency of 13.56 MHz.

With reference to FIG. 1, the antenna 100 further comprises a second radiating element 116. The second radiating element 116 has a ground portion 118 connected to a first section 120 of the first radiating element 102 distal to the impedance matching network 112. The ground portion 118 is preferably formed on the same side 103 of the substrate 104 as the first radiating element 102. The ground portion 118 has a geometrical shape such as a polygon, an ellipse or a circle. The geometrical shape of the ground portion 118 is independent of the geometrical shape of the first radiating element 102.

The ground portion 118 preferably has a loop-shaped slot 122 including a first slot 124 a and a second slot 124b formed therein. The loop-shaped slot 122 preferably has a geometrical shape such as a polygon, a circle or an ellipse. Each of the first and second slot 124a, 124b preferably extends substantially diagonally along a diagonal line 126 from the loop-shaped slot 122. The first and second slots 124a, 124b preferably extend towards each other. The ground portion 118 is preferably substantially symmetrical about the diagonal line 126.

Each of the first and second slot 124a, 124b and the loop-shaped slot 122 preferably has uniform width therethroughout. The first and second slots 124a, 124b are preferably dimensionally similar.

An impedance matching slot 128 is preferably formed in the ground portion 118 for matching the impedances of the second radiating element 116 and a second feed 130. The second feed 130 is connected to the second radiating element 116. The impedance matching slot 128 is preferably formed adjacent to the first section 120 of the first radiating element 102 and preferably has a uniform width therealong. In this way, a portion of the first section 120 of the first radiating element 102 forms one part of the ground portion 118 of the second radiating element 116 for defining a common portion between the first and second radiating elements 102, 116.

The second feed 130 is preferably formed on a second side 105 of the substrate 104 opposite to the first side 103 of the substrate 104. The second feed 130 is used for providing a second current to the second radiating element 116 for generating a second field. The second field generates an electromagnetic field for propagating electromagnetic radiation in the radio or microwave frequency range.

The second radiating element 116 is suitable for operating at ultra-high frequency (UHF) or microwave frequency mode. The second radiating element 116 is therefore capable of generating radio waves for use in far field RFID applications. Exemplary operating frequency bands of the second radiating element 102 are 860 to 870 MHz, 902 to 928 MHz, 950 to 960 MHz, 2.4 GHz and 5 GHz bands. The second radiating element 116 is advantageously configured for generating circular polarization radiation.

The first and second radiating elements 102, 116 are preferably made of copper and are preferably formed as a continuous metallic strip or conductive wire. The first and second radiating elements 102, 116 may also be made of inductive ink and formed by using printing technology.

Additionally, the first and second radiating elements 102, 116 may be curved for conforming to a curved surface or substrate on which the antenna 100 is formed.

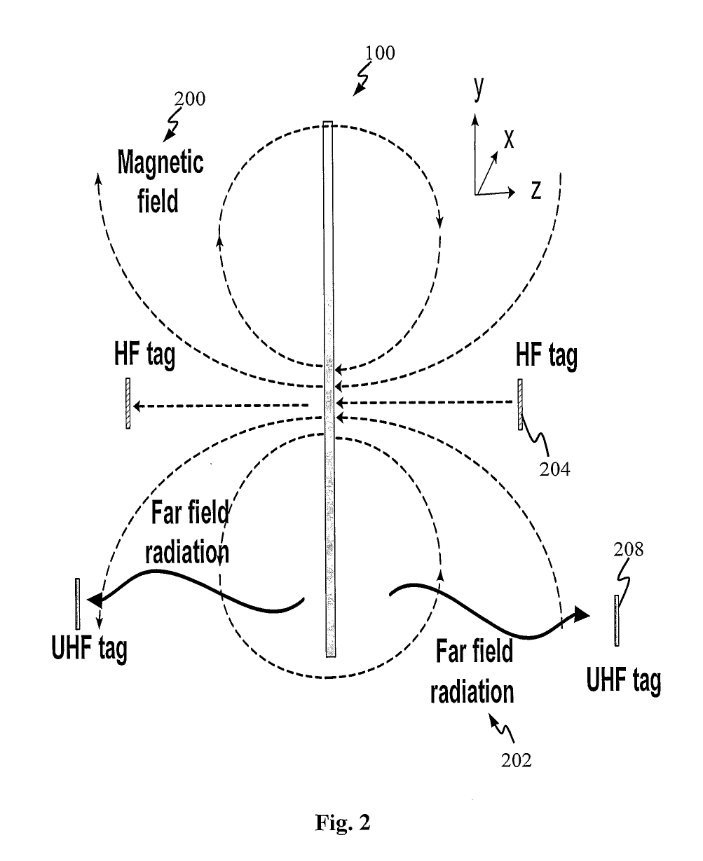

FIG. 2 shows a side view of the antenna 100 along the y-axis. During operation of the antenna 100, the first current flows through the first radiating element 102 via the input terminals 114a, 114b and the second current flows through the second radiating element 116 via the second feed 130. The first current excites the loop element 106 of the first radiating element 102 to thereby produce a magnetic field 200 in which near field RFID is applicable.

The magnetic field 200 energizes and powers up HF RFID tags 204 that are provided within the operating distance of the antenna 100. The HF RFID tags 204 subsequently produce RFID signals that contain tag data stored therein. The RFID signals are in turn received by the first feed via the first radiating element 102.

The second current excites the second radiating element 116 to thereby produce far field electromagnetic radiation 202 for detecting and sensing UHF RFID tags 208. The far field electromagnetic radiation is radiated bi-directionally away from the antenna 100, as shown in FIG. 2.

The antenna 100 is advantageously capable of simultaneously generating magnetic and electromagnetic fields for supporting near field and far field RFID applications respectively. The antenna 100 is desirably used for integrating RFID systems having separate antenna modules for operating in HF and UHF modes.

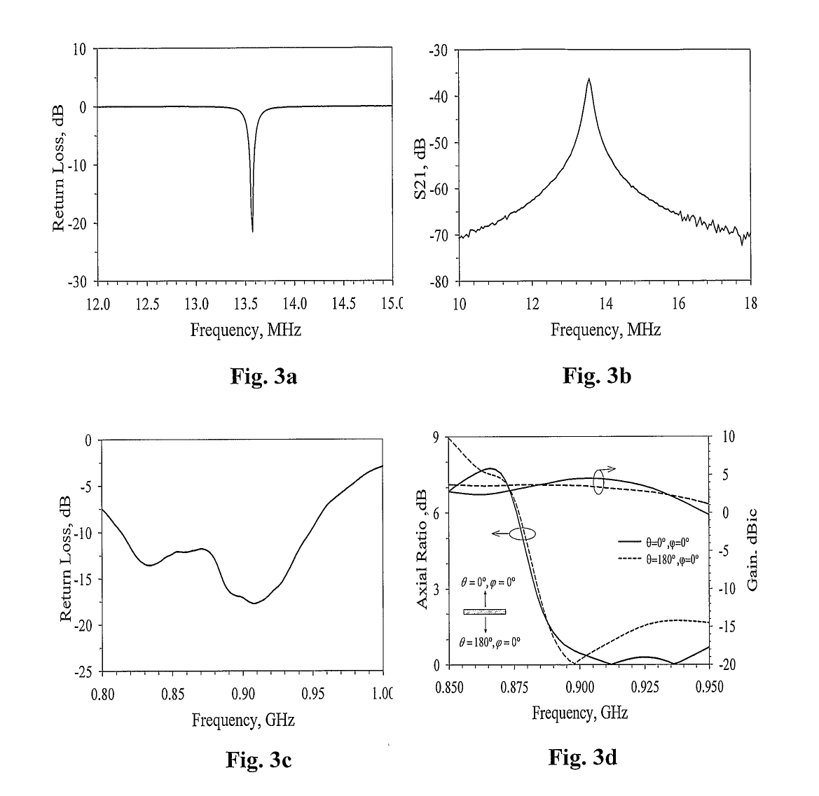

FIG. 3a is a graph that shows measured return loss of the antenna 100 operating at 13.56 MHz. The measured results show the antenna 100 having a well-matched impedance matching characteristic at the measured frequency of 13.56 MHz. FIG. 3b shows the field response of the antenna 100 operating at 13.56 MHz.

FIG. 3c illustrates the measured return loss of the antenna 100 operating at UHF band. The measured return loss is less than −15 dB over the UHF band of 902 to 928 MHz.

FIG. 3d is another graph showing measured gain and axial ratio of the antenna 100 operating at the UHF band. The maximum gain of 4.5 dBic is obtained along the positive z-axis direction (θ=0°, φ=0°), while a 3.5 dBic gain is obtained along the negative z-axis direction (θ=180°, φ=0°). Desirable axial ratio measurements are observed along the positive and negative z-axis directions. The measured axial ratios along the positive and negative z-axis directions are less than 1 dB and less than 2 dB respectively.

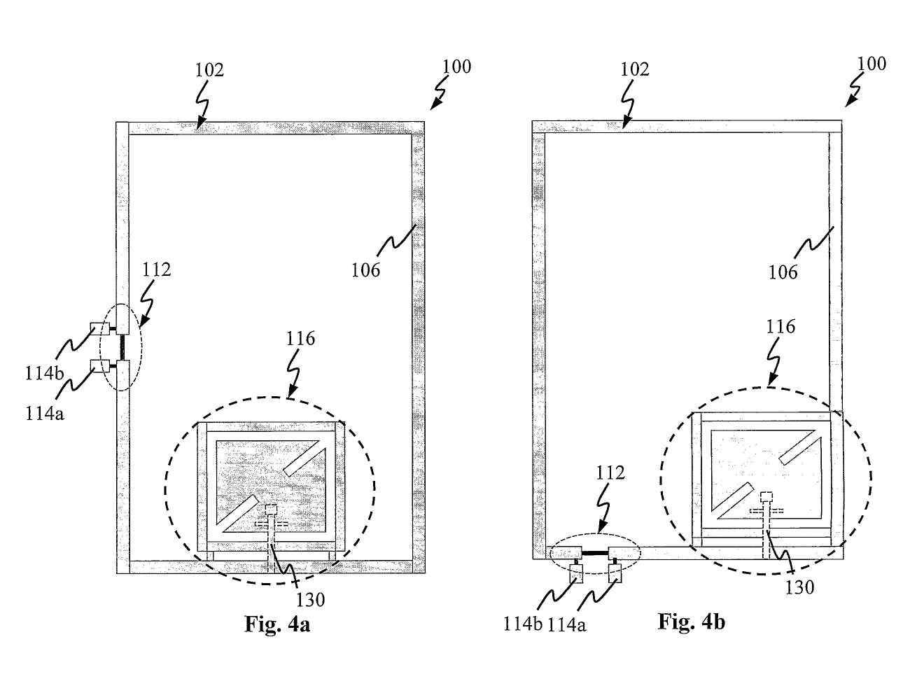

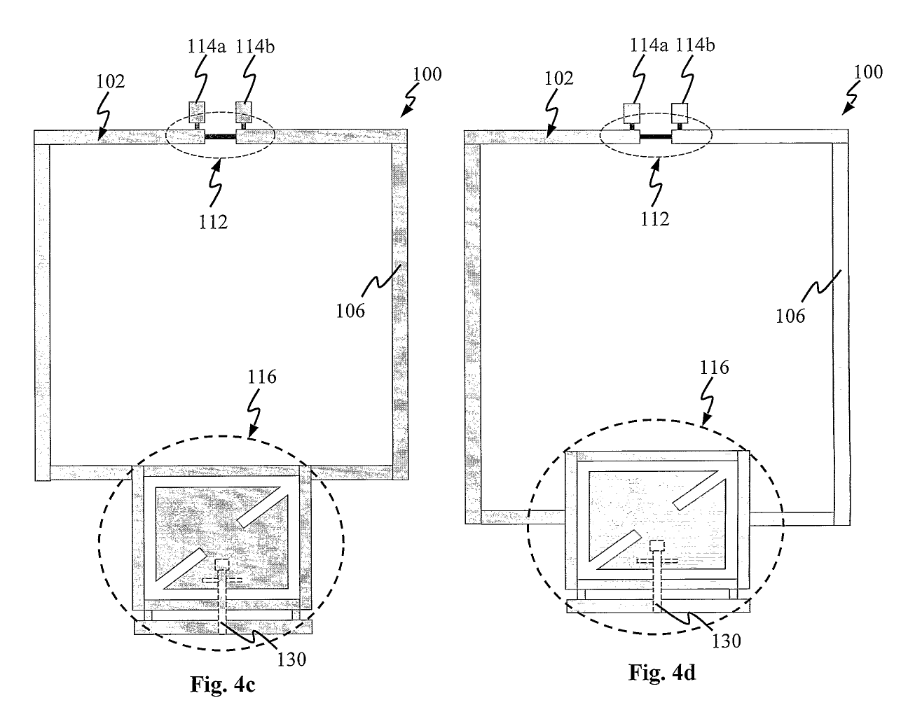

FIGS. 4 to 6 illustrate other embodiments of the antenna 100 having exemplary configurations and are described hereinafter.

With reference to FIGS. 4a and 4b, the impedance matching unit 112 is shown to be connectable to different sections of the first radiating element 102. FIG. 4b specifically shows that the second radiating element 116 is connectable to two adjacent sections of the first radiating element 102. FIGS. 4c and 4d show that the loop element 106 of the first radiating element 102 is connectable to different parts of the ground portion 118 of the second radiating element 116.

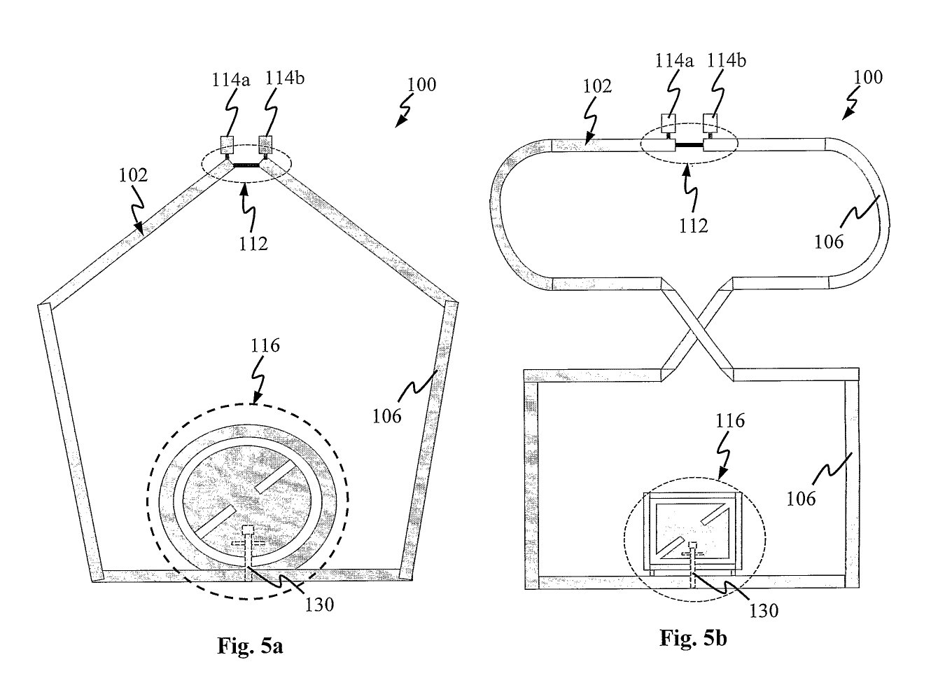

FIG. 5a shows alternative geometrical shapes of the loop element 106 of the first radiating element 102 and the ground portion 118 of the second radiating element 116. FIG. 5b shows that the first radiating element 102 comprises two interconnected loop elements 106 having different geometrical shapes for increasing the spatial extent of the magnetic field 200. The first radiation element 102 may consist of more than two loop elements 106 for further increasing the extent of the magnetic field 200.

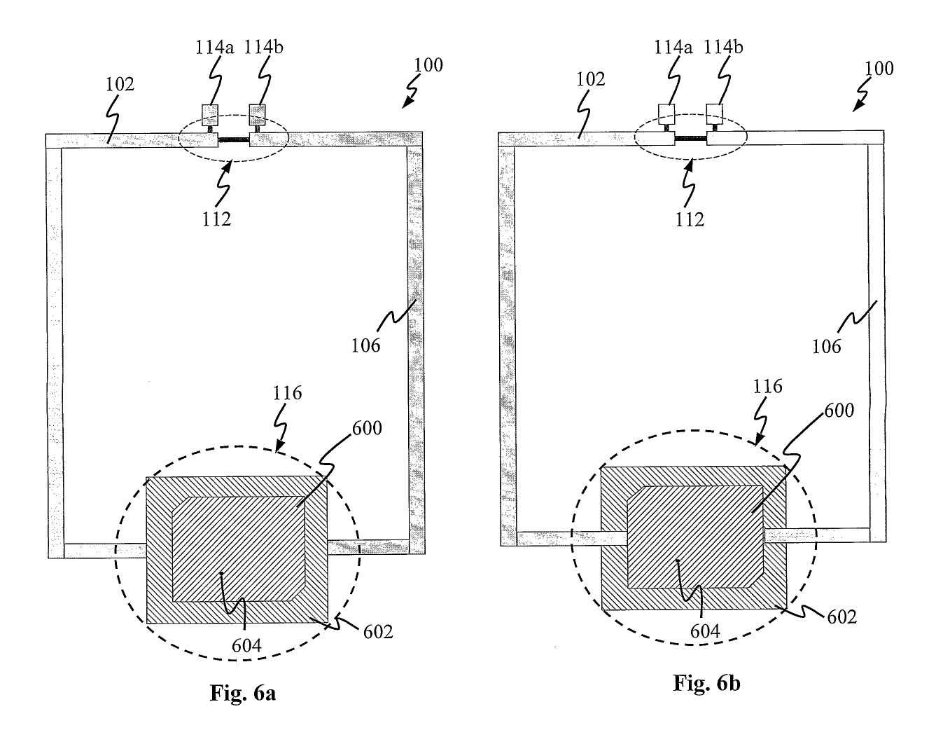

FIGS. 6a and 6b show that the second radiating element 116 comprises a plate radiator 600 and a ground patch 602. The plate radiator 600 and the ground patch 602 are preferably planar and parallel to each other. The plate radiator 600 is preferably rectanglarly shaped including two diagonal corners that are beveled. The plate radiator 600 and ground patch 602 are further spatially displaced and interconnected by a connector (not shown).

With reference to FIG. 6a, the ground patch 602 is directly connected to the loop element 106 of the first radiating element 102 and is further connected to the plate radiator 600 at a feed point 604 formed on the plate radiator 600. With reference to FIG. 6b, the plate radiator 600 is directly connected to the loop element 106 of the first radiating element 102 and is further connected to the ground patch 602 at the feed point 604 of the plate radiator 600. The embodiments of the antenna 100 as shown in FIGS. 6a and 6b are capable of generating circular polarization radiation. The electromagnetic radiation generated by the embodiments of the invention as shown in FIGS. 6a and 6b radiates unidirectionally away from the antenna 100.

In the foregoing manner, an antenna for an RFID system for use in near field and far field RFID applications is disclosed. Although only a number of embodiments of the invention are disclosed, it becomes apparent to one skilled in the art in view of this disclosure that numerous changes and/or modification can be made without departing from the scope and spirit of the invention. For example, the second radiating element may be formed as a spiral radiator for generating bidirectional circular polarization radiation for supporting far field RFID applications.

1. An antenna for radio frequency identification, the antenna comprising:
a first radiating element for operating a first mode of radio frequency identification using a first current; and
a second radiating element for operating a second mode of radio frequency identification using a second current,
wherein at least one of a portion of the first radiating element forms a portion of the second radiating element and a portion of the second radiating element forms a portion of the first radiating element,
wherein when the first radiating element is excited by the first current, the first radiating element generates a first field for providing the first mode of radio frequency identification, and when the second radiating element is excited by the second current, the second radiating element generates a second field for providing the second mode of radio frequency identification.

2. The antenna of claim 1, wherein at least one of the first and second currents flows in the one of at least one portion of the first radiating element forming a portion of the second radiating element and at least one portion of the second radiating element forming a portion of the first radiating element.

3. The antenna of claim 1, wherein the first field is a magnetic field and the first mode of radio frequency identification is near field radio frequency identification.

4. The antenna of claim 1, wherein the second field is an electromagnetic field and the second mode of radio frequency identification is far field radio frequency identification.

5. The antenna of claim 4, wherein the electromagnetic radiation is circularly polarized.

6. The antenna of claim 1, wherein the second radiating element radiates bi-directional electromagnetic radiation.

7. The antenna of claim 1, wherein the second radiating element radiates unidirectional electromagnetic radiation.

8. The antenna of claim 1, wherein the second radiating element has a plate radiator and a ground patch, the plate radiator and the ground patch being interconnected by a feed.

9. The antenna of claim 8, wherein the ground patch forms a portion of the first radiating element.

10. The antenna of claim 8, wherein each of the plate radiator and the ground patch is substantially planar.

11. The antenna of claim 8, wherein the plate radiator is substantially spatially displaced away from the ground patch are substantially spatially displaced.

12. The antenna of claim 8, wherein the second radiating element is excited via the feed.

13. The antenna of claim 1, wherein an impedance matching circuit is couplable to the first radiating element.

14. The antenna of claim 13, wherein the first radiating element is excited via the impedance matching circuit.

15. The antenna of claim 1, wherein the first radiating element comprises at least one loop element.

16. The antenna of claim 1, wherein the first radiating element being shaped as one of polygon, ellipse, circle and semi-circle.

17. The antenna of claim 1, wherein the second radiating element has a geometrical shape that is independent of the geometrical shape of the first radiating element and comprises one of polygon, ellipse and circle.

18. The antenna of claim 1, wherein each of the first and second radiating elements are planar.

19. The antenna of claim 1, wherein the first and second radiating elements are curved to conform to a curved surface on which the first and second radiating elements are formed.

20. The antenna of claim 1, wherein the antenna is substantially unitary.

21. A method for configuring an antenna for radio frequency identification, the method comprising the steps of:
providing a first radiating element for operating a first mode of radio frequency identification using a first current; and
providing a second radiating element for operating a second mode of radio frequency identification using a second current,
wherein one of a portion of the first radiating element forms a portion of the second radiating element and a portion of the second radiating element forms a portion of the first radiating element,
wherein when the first radiating element is excited by the first current, the first radiating element generates a first field for providing the first mode of radio frequency identification, and when the second radiating element is excited by the second current, the second radiating element generates a second field for providing the second mode of radio frequency identification.

22. The method of claim 21, wherein the step of providing a second radiating element for a second mode of radio frequency identification further comprising the step of providing a plate radiator and a ground patch, the plate radiator and the ground patch being interconnected by a feed.

23. The method of claim 21, wherein the step of providing a plate radiator and a ground patch further comprising the step of forming the ground patch as part of the at least one portion of the first radiating element.

24. The method of claim 21, further comprising the step of providing an impedance matching circuit couplable to the first radiating element.

25. The method of claim 21, further comprising the step of providing circularly polarized electromagnetic radiation.

26. The method of claim 21, wherein the step of providing a second radiating element for a second mode of radio frequency identification further comprising the step of providing bidirectional electromagnetic radiation generated by the second radiating element.

27. The method of claim 21, wherein the step of providing a second radiating element for a second mode of radio frequency identification further comprising the step of providing unidirectional electromagnetic radiation generated by the second radiating element.

28. The method of claim 21, wherein at least one of the first and second currents excites the one of at least one portion of the first radiating element forming a portion of the second radiating element and at least one portion of the second radiating element forming a portion of the first radiating element.

29. The method of claim 21, wherein the first field is a magnetic field and the first mode of radio frequency identification is near field radio frequency identification.

30. The method of claim 21, wherein the second field is an electromagnetic field and the second mode of radio frequency identification is far field radio frequency identification.
